(19) United States
(12) Patent Application Publication
(10) Pub. No.: US 2009/0305667 A1
(43) Pub. Date: Dec. 10, 2009

(54) Method and system for mobile identity verification and security

(76) Inventor: Michael J. Schultz, San Jose, CA (US)

Correspondence Address: DOUGLAS C. WYATT;Wyatt, Gerber & O'Rourke, L.L.P., 99 Park Avenue, New York, NY, 10016, US

(21) Appl. No.: 12/387,681

(22) Filed: May 6, 2009

Related U.S. Application Data
(63) Continuation-in-part of application No. 11/789,742, filed on Apr. 24, 2007.

(51) Int. Cl. H04M 1/66

(52) U.S. Cl. 455/410

(57) ABSTRACT

A system and method for mobile identify identification and security over a communications network is provided. The system and method include validation processes which provide for an increasing level of intrusion and/or user interaction.

### RELATED APPLICATIONS

This application is a continuation-in-part to U.S. patent application Ser. No. 11/789,742 filed Apr. 24, 2007, the disclosure of which is incorporated herein by reference.

### FIELD OF THE INVENTION

The invention relates to identity security techniques. The invention is especially useful for verifying user identities and mobile devices for secure communication. More particularly, the invention provides a method for verifying user identities and mobile devices for secure transactions.

### BACKGROUND OF THE INVENTION

Current methodologies for identity verification and security include methods such as entering a PIN or password on a mobile device to unlock the device, and entering a PIN or password registered with a service provider. In addition, identification of a user can be provided through biometric verification such as retinal scan, voiceprint or thumb/fingerprint scan extending to high level security using a device that creates randomly generated encryption keys and which can interact with a service provider, USB keyfobs or memory cards which can be installed on a mobile device to validate a user. To a limited extent, LBS (location based services) can be applied to a mobile device and limit services by location.

Users of mobile devices, such as cell phones, laptops, and other devices often need secure communications and robust identity confirmation in order to perform sensitive transactions. A problem with existing systems is that individual methods of identity verification possess flaws that are sometimes unique to a technology while other flaws are shared by multiple technologies. These weaknesses can be exploited to allow the device to be co-opted and a false identity confirmation to be validated through the mobile device or a clone of that device.

Current methods to confirm an identity of a mobile device include, but are not limited to, the International Mobile Equipment Identity (IMEI) of the device itself; the device registration of the mobile device on a network; a PIN or password entered into an application hosted within the mobile device that is transmitted through a network or other methods such as Bluetooth or WiFi connection as well as the use of a GPS or LBS system to validate a user of the mobile device.

The use of multiple technologies to create and affirm a validated digital identity combines the strengths of individual technologies. However, merely combining known technologies to provide layers of protection are often insufficient because once a sequence is known and the ability to work around each module has been created it can be a simple matter of defeating each access module individually. An example is assigning a PIN to unlock a mobile device, a password to access a service through the mobile device and a memory card that carries an encryption key to further identity the mobile device and its associated user. An identity thief who has stolen a mobile device and who knows the unlock PIN and a service password can replicate the actions of the authorized user to access a service. Addition of other security means, such as LBS, can be used to mitigate this type of theft, however the identity thief could attempt access in authorized access areas or use a GeoIP proxy to create a false location.

### OBJECT OF THE INVENTION

It is an object of the invention to provide an improved method and device to overcome the deficiencies of prior security and identify validation systems.

It is an object of the invention to provide an authentication system for use by individuals who rarely authenticate to a system.

It is an object of the invention to provide an authentication system which is not entirely dependent upon passwords.

It is an object of the invention to provide a system which minimizes impact on privacy.

It is an object of the invention to provide a system which can be incorporated into and is compatible with other trusted systems and other verification systems and methods.

It is an object of the invention to provide reliable and accurate, ergonomically from the stand point of a legitimate user.

It is an object of the invention to provide a system which prevents illegitimate use through guessing and other security breaching techniques.

### SUMMARY OF THE INVENTION

The invention relates to systems which bond a mobile device to a human identity utilizing processes and devices during an initial validation or authentication process as well as throughout the implementation and use of the bonded digital identity using a mobile device. While current systems heavily rely on a single methodology approach, or at best a series of individual technologies utilized in sequence, a system according to the invention utilizes a control method that determines when a specific subset of technologies should be used to validate a mobile identity based on the use of that identity. The application can also utilize the mobile identity as well as specific parameters set by the user and/or service provider that relies on the mobile identity.

### BRIEF DESCRIPTION OF THE DRAWINGS

Preferred embodiments of the inventive devices are illustrated in the drawings and will be described below.

FIG. 1 illustrates an identity verification and security system according to the invention.

FIG. 2 illustrates a method of providing identity verification and security according to the invention.

FIG. 3 illustrates a method of providing identity verification and security according to the invention.

FIG. 4 illustrates a method of providing identity verification and security according to the invention.

Throughout the figures, the same reference numerals and characters, unless otherwise stated, are used to denote like features, elements, components or portions of the illustrated embodiments. Moreover, while the subject invention will now be described in detail with reference to the figures, it is done so in connection with the illustrative embodiments. It is intended that changes and modifications can be made to the described embodiments without departing from the true scope and spirit of the subject invention as defined by the appended claims.

### DETAILED DESCRIPTION

A detailed description of the devices and methods for mobile identity verification and security is provided below for general applicability. In addition, several specific embodiments are provided as examples of the devices and methods with which one of ordinary skill in the art may apply these teachings to address specific problems and to illustrate the benefits and improvements of the system and method over known solutions.

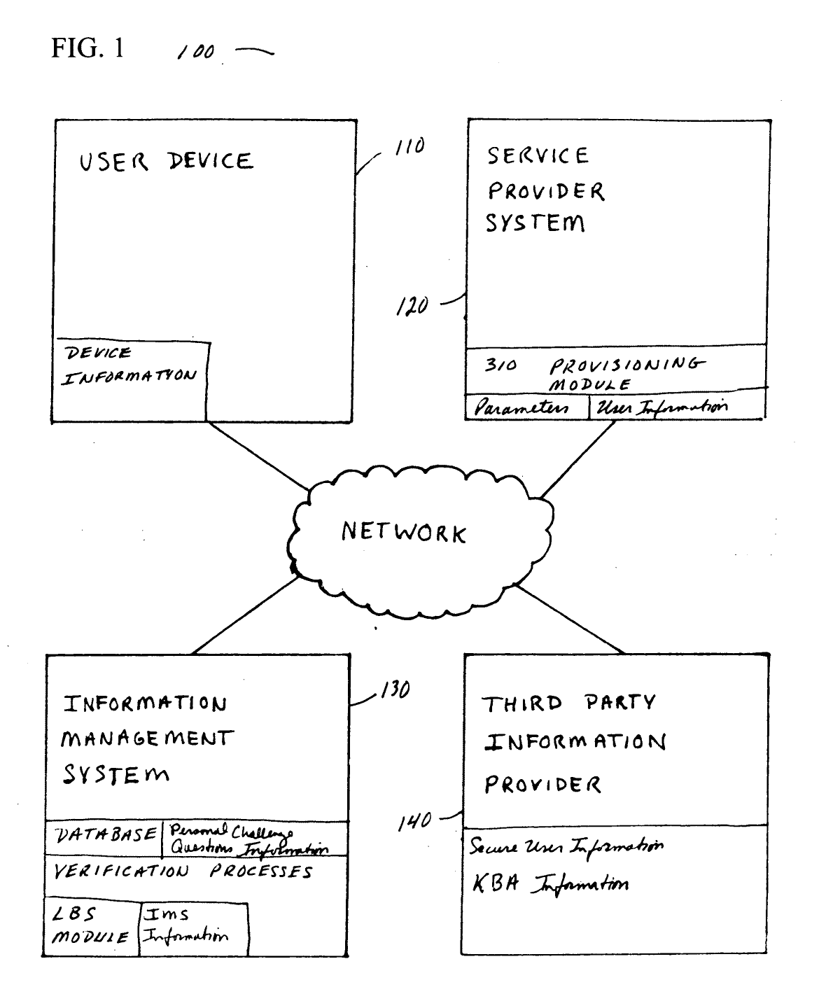

An embodiment of a system and method for mobile identity verification and security 100 according to the invention is shown in FIG. 1. An identity verification and security system according to the invention can include at least one user device 110, a service provider system 120, and an information management system 130. The system 100 can be operably connected through a communications network. The system 100 can also include at least one third party information provider 140.

A user device 110 can be a mobile device which uses an OTA (Over The Air) network to provide voice and/or data communication between users and/or machines. For example, a user device 110 can include, according to embodiments, a mobile phone, personal digital assistant (PDA), and other embedded portable devices. According to other embodiments, a user device 110 may comprise a mobile or portable computer. Artisans will recognize that although the principles of the present disclosure are couched in terms of mobile computing, the same principles are applicable to nearly any device capable of executing machine readable instruction.

A user device 110 includes a control module and/or processor; an input mechanism, such as keypad; and an output mechanism, such as a display. The display can show content on the user device 110 according to processes described herein which can be provided through the control module. For example, the control module can provide a user interface. Depending on the device, artisans will recognize the applicable input mechanisms that may be employed to operate the systems and method of the present disclosure. In addition, the user device 110 can include a communications module for sending and receiving information to one or more other devices, such as through a network.

A service provider system 120 according to the invention can include one or more general purpose computers. In addition or in the alternative, a service provider system 120 can include one or more machines having application specific integrated chips designed to perform one or more of the processes and methods described herein.

A service provider system 120 can include a service provisioning module 310 which can be adapted to perform one or more of the processes described herein. A service provisioning module 310 can include an application specific device, and or software adapted to perform the processes of the service provisioning system.

A service provider system 120, as described herein, should not be confused with current mobile operator systems. Current mobile operator systems, such as commercial wireless communications providers, simply provide a voice/data network over which is transported communication. Although a service provider system 120 can be incorporated into such systems, an embodiment of a service provider system 120 according to the invention is preferably a system adapted for use for an entity that provides a specific service or services, such as, Facebook Mobile. Such an application can be hosted by mobile operators who provide servers, computing power and storage as well as the data communications network. However, the actual provisioning and service abilities are provided by Facebook as the service provider.

The service provider system 120 can provide account management for a user to use or benefit from one or more services offered by the service provider system 120. The service provisioning module can be adapted for entry, storage and transmission of data related to service account.

Associated services can include medical benefit services such as automotive theft prevention, medical insurance, mobile purchasing, mobile banking, mobile interaction with a social network or interpersonal service, mobile gaming and other applications that can or do incorporate mobile devices as an entry or identity authentication tool. These service providers all have in common the need to limit access to their service to authorized users and as such are required to validate the identity of any user. This is not required for public services such as Google or Yahoo who do not require user identity authentication. The service provider will determine when a user must be authenticated prior to usage and what levels of authentication and increased validation are required for their particular service or services.

An information management system 130 is provided which can include one or more general purpose computers. In addition or in the alternative, an information management system 130 can include one or more machines having application specific integrated chips designed to perform one or more of the processes and methods described herein.

In one embodiment, the information management system 130 includes at least one control processing unit (CPU) or processor. The CPU can be coupled to a memory, ROM or computer readable media containing the computer-executable instructions adapted to perform the processes described herein for the information management system 130. Computer readable media can be any available media that can be accessed by the system and includes both volatile and nonvolatile media, removable and non-removable media implemented in any method or technology for storage of information such as computer readable instructions, data structures, program modules or other data. Computer storage media includes, but is not limited to, RAM, ROM, EEPROM, flash memory, portable memory or other memory technology, CD-ROM, digital versatile disks (DVD) or other optical disk storage, magnetic cassettes, magnetic tape, magnetic disk storage or other magnetic storage devices, or any other medium which can be used to store the desired information. Communication media typically embodies computer readable instructions, data structures, and program modules. By way of example, and not limitation, communication media includes wired media such as a wired network or direct-wired connection, and wireless media such as acoustic, RF, infrared, and other wireless media. Combinations of any of the above should also be included within the scope of computer readable media. The computer readable media may store instructions or data which implement all or part of the system described herein.

It can be appreciated that a communications network can be utilized by a system according to the invention for communicating information among parts of a system according to the invention. According to embodiments, communications through the network can be performed using the Hypertext Transfer Protocol (HTTP) and other secure communications. Accordingly, other protocols are similarly contemplated, according to embodiments including, DHCP, DNS, PTP, IMAP4, MIME, POP3, SIP, SMTP, SNMP, SSH, TELNET, HTTP, HTTPS, BGP, RPC, RTP, RTCP, TLS/SSL, SDP, SOAP, L2TP, PPTP, and others known and understood by artisans, according to embodiments. According to different embodiments, communication through the network can be performed via TCP internet protocol, which in turn can operate over any of several types of physical networks, including cellular phone networks. Other communications protocols are likewise contemplated according to embodiments, such as TCP, TCP/IP, UDP, DCCP, SCTP, GETP, WAP Datagram protocol, and others that would be known and understood by artisans.

The system can also include at least one third party information provider 140. The third party information provider 140 can include a communications means for sending and receiving information, preferable through a network. As described more fully within, the third party also can include a data base comprising information such as user information, secure user information and/or knowledge based authentication (KBA questions and associated KBA answers).

A system according to the invention can be operably designed to include the methods and processes described herein, such as steps authenticating the identity of a user, such as for initialization of a user account associates with a service of a service provider; and for validating the identity of a user, such as when a user accesses or uses the services.

The processes and methods herein may be described in the general context of computer-executable instructions, such as program modules, being executed by a computer. Generally program modules include routines, programs, objects, components, and data structures that perform particular tasks or implement particular abstract data types. The system may also be practiced in distributed computing environments where tasks are performed by remote processing devices that are linked through a communications network. In a distributed computing environment, program modules may be located in both local and remote computer storage media including temporary storage devises. The computer programs are stored in a memory medium or storage medium or they may be provided to a processing unit through a network or I/O bus.

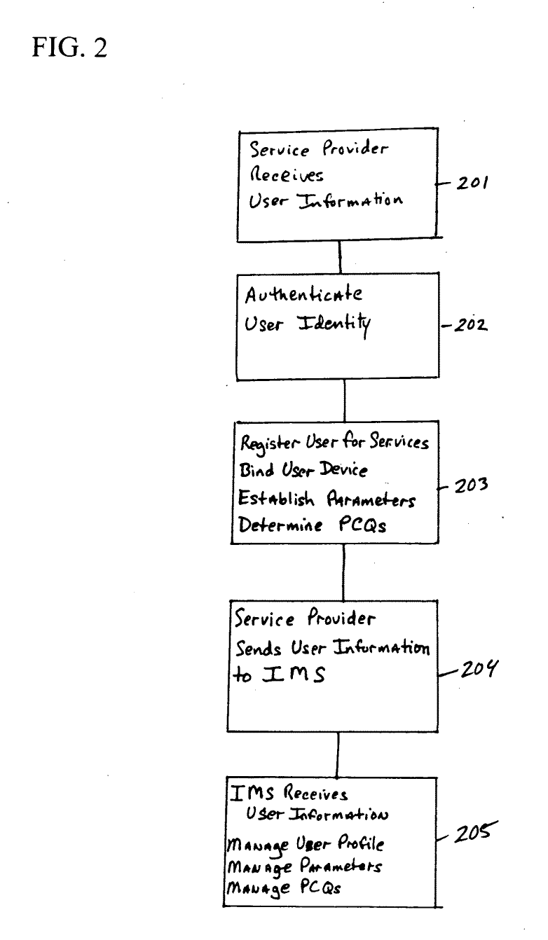

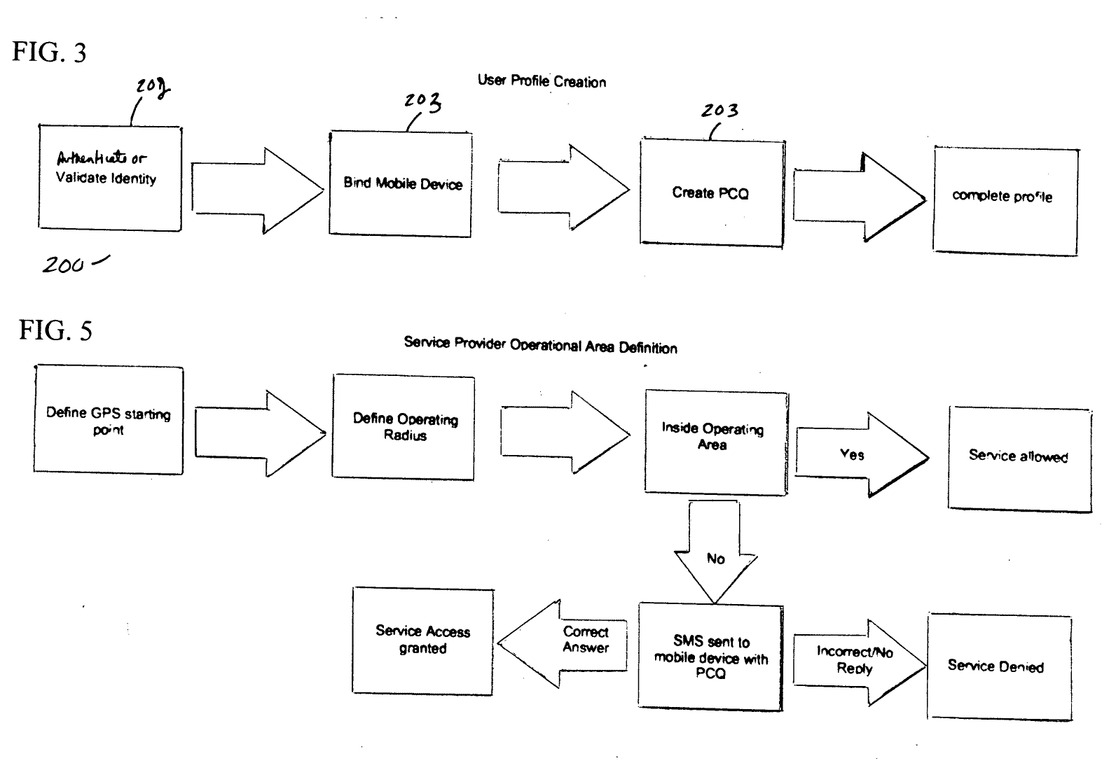

As shown in FIGS. 2 and 3, methods according to the invention include initialization processes 200. Generally, initializing processes can include a user communicating with a service provider to register for services provided by the service provider, the service provider receiving user information, authenticating the user's identity, and binding a user mobile communication device to be used for other verifying procedures.

More specifically, a user can contact a service provider 120 to validate the user's identity and can do so by using a user device 110 which can communicate with a service provider 120 system through a network. The service provider can authenticate 202 a user's identity using a number of methods, including validation processes described herein.

The process of authentication (i.e., initial verification) of a user's identity provides a high-level of confidence in the user's identity to ensure the user's identity is authenticated to a degree acceptable to the service provider. Once a user's identity is satisfactorily authenticated, a user device 110, such as a cell phone, can be associated with (or “bound to”) the user 203.

Once the device 110 is bound to the user, the device 110 can be used for verification of the user's identity.

Accordingly, a method according to the invention can include a process wherein a user communicates with a service provider to provide user information, such as by using a portable user device 10. The service provider can offer the user the option to subscribe 203 to or benefit from services provided by the service provider. In addition, the service provider can provide the user with the option to receive verification and authentication services associated with the services offered by the service provider. For example, a service provider can be an insurance provider which permits a user to sign up for insurance policy services associated with verification services. The verification services can provide additional security to ensure the proper use of the medical benefits by requiring verification of the user's identity before the insurance policy services may be utilized.

Preferably, the method includes the service provider requesting 201 certain initial identification information from the user and/or user device to begin the initial authentication process. Identification information is information which the service provider can use to identify a user and associate the user's identity with one or more records maintained by a trusted entity, or third party information provider. Preferably, initial identification information is information which is known to a user and reasonably available to a user. In addition, initial identification information can be information which can be compared to secure user information held by a trusted entity. Initial identification information can include name, date of birth, identification number, and bank account number, among other things.

Initial identification information can also include account information known to a trusted entity, such as cell phone account information, bank account information, gas or electric entity account information, as well as mobile device information to identify a mobile device associated with the user. In addition, or in the alternative, PCQ (Personalized Challenge Questions) can be used which can be used to identify a user, and which is described more fully herein.

A user and/or user device can provide initial identification information to the service provider. It can be appreciated that initial identification information can be provided in a number of ways, such as the user device 110 sending one or more records containing the information, a user communicating the information over the network through a web portal maintained by the service provider, as well as verbally communicating the information to the service provider.

In addition, the service provider 120 system can request account information 203 from a user and/or user device to initialize an account associated with the user, which account can be maintained by the service provider 120 system. For example, account information can include information related to how a user intends to pay for the services, among other things. The service provider can store the user information and use the information collected from the user to define parameters which can be determined by the service provider to define aspects of the services associated with the user.

The service provider can send 204 all or a portion of the initial identification information of the user and the parameters determined by the service provider to an information management system 130 which the information management system can use to obtain authentication of a user's identity from third party users. A service provider may store information to prove identity authentication, in addition to information being stored by the information management system.

The information management system can receive and store 205 the initial identification information in a database record associated with the service provider. In addition, the information management system 130 can store information related to the service provider with this information, such as information related to the service provider's services.

For example, post initiation transactions of a user can be time-stamped to show when the service was accessed, how verification was done, whether any escalation in verification processes was performed by the system, and the results.

As shown in FIG. 3, the information management system can request and receive 206 secure user information from one or more third party information providers (TPIPs), such as reporting agencies and other trusted entities including, but not limited to, credit reporting agencies. User information can be used to generate Personalized Challenge Questions (PCQs) and or Knowledge Based Authentication (KBA) questions.

Secure user information is preferably information which is not readily available to the public but is reasonably available or likely to be within the knowledge of the user. A PCQ can be included to provide a higher level of security for logging into a service as described more fully herein. More specifically, secure user information can be information stored by a TPIP, which information is not generally well known and which is typically available only to a user and to one or more third parties which do not disseminate the information to the public. In addition, or in the alternative, secure user information includes information that is available only to a user and to one or more third parties which have an obligation to the user to keep the information confidential. In addition, or in the alternative, secure user information includes information that is known only to a user and to one or more third parties which have an obligation to the user to keep the information confidential.

For example, secure user information can include a password associated with the user, the name of the user's favorite book, the latest transaction of the user from a financial account maintained by the user, the name of the user's first pet, the maiden name of the user's mother, among other things.

As part of the request 206, the information management system 130 can send all or a portion of the user initial identification information to the trusted entity or TPIP 140, which information can be used to locate records of secure user information, and provide authentication responses, among other things. For example, an information management system 130 can submit identity information, such as a user's name, address and/or telephone number, to generate a match to an entry in a database maintained by one or more third party information providers, and obtain a response indicating whether the user's identity information is authenticated.

As part of the request 206, the information management system can also provide IMS verification information related to the information management system, to verify the legitimacy of the information management system's request for secure information from the trusted entity or TPIP. Verification information can include secure information previously established and shared between the information management system and the trusted entity or TPIP, and can be used by the TPIP to verify the identity of the information management system 130, and/or to verify its request and permit the IMS to receive secure user information and/or an authentication response from the trusted entity or TPIP 140.

The third party information provider can provide 206 TPIP information to the information management system. In addition, or in the alternative, the TPIP can provide 206 at least one Knowledge Based Authentication (“KBA”) question and an associated KBA answer to the information management system as part of a validation process or authentication process.

KBA questions are questions which can be derived from either user information and/or user information associated with an individual, and preferably an individual corresponding to the identity of the user. Knowledge Based Authentication (“KBA”) questions can include questions derived from secure user information. Preferably, KBA questions are derived from secure, non-public information, such as that which may be held by trusted entities, but can also include other information from sources such as third party information providers and public information sources. For example, secure user information can be held by public credit reporting agencies, and private reporting companies such as Lexus Nexus.

KBA questions can also be derived from unassociated user information which may be held by a TPIP and which is general information related to a user and not necessarily specifically associated with any particular TPIP. Unassociated user information can include: Auto information, such as vehicle make, vehicle model, vehicle year, vehicle color, and or vehicle license plate; Address information, such as previous street name, previous city name, county name, street city name, household member; Property information, such as year home built, home value; SNN information, such as last 4 digit SSN, SSN issue state; Personal Information, such as year of birth and education; Employment information, such as profession; Null Set information/questions (questions formed such that the answer is always “None Of The Above”), people living with a user, retail credit card, bank institution and previous phone number; and Bogus information, such as bogus mortgage lender, bogus mortgage amount, bogus auto lender, bogus auto amount and bogus address. Bogus information includes information used by the credit reporting agencies.

In addition, KBA questions can be derived from associated user information relating to the type of TPIP and/or associated with a particular TPIP. For example, KBAs can be derived from credit related TPIPs, including Mortgage information, such as mortgage lender (opened, closed account), mortgage amount; Auto information, such as auto loan lender (opened, closed account), auto loan amount, vehicle make, vehicle model, vehicle year, vehicle color, vehicle license plate; Address information, such as previous street name, previous city name, county name, street city name, household member; Student Loan Information, such as student loan lender, (opened, closed account), student loan amount; Property Information, such as year home built, home value; SSN Information, such as last 4 digit SSN, SSN issue state; Personal Information, such as year of birth, education; Employment Information such as employer name, business name, profession; Null Set Information, such as people living with a user, retail credit card, bank institution, previous phone number; and Bogus Information, such as bogus mortgage lender, bogus mortgage amount, bogus auto lender, bogus auto amount and bogus address.

Generally, KBA questions can be chosen from factoids which are preferably easily recalled by an individual (personal or other information known to the individual, but not likely to be known to others, most especially specific, potential fraudulent users). In one embodiment, KBA questions can be derived from “Out-of-wallet” and non-credit related information, and exclude PCQ type questions. Accordingly, KBA questions can include date of birth, place of birth, cell phone number. In one embodiment, KBA questions are presented with multiple choice answers. For example, in one embodiment KBA questions can be divided into 8 categories, some of which can be provided with multiple subsets. For example, one category can include previous address of a user. If the user had 6 previous addresses, the system could generate 6 KBA questions for each such previous address, and for each such address additional KBA questions can be generated from the address details, such as street, zip code, city, and state.

For each KBA question, an associated KBA answer is also derived which are associated with an individual. The information management system 130 can receive TPIP information, including secure user information and/or KBA questions and associated KBA answers from one or more third party information providers and generate a KBA list 207 of one or more KBA questions and associated answers. In an alternative embodiment of the invention, the information management system can derive knowledge based authentication questions and associated KBA answers based on the TPIP information associated with an individual, and the TPIP information in one or more records associated with the user.

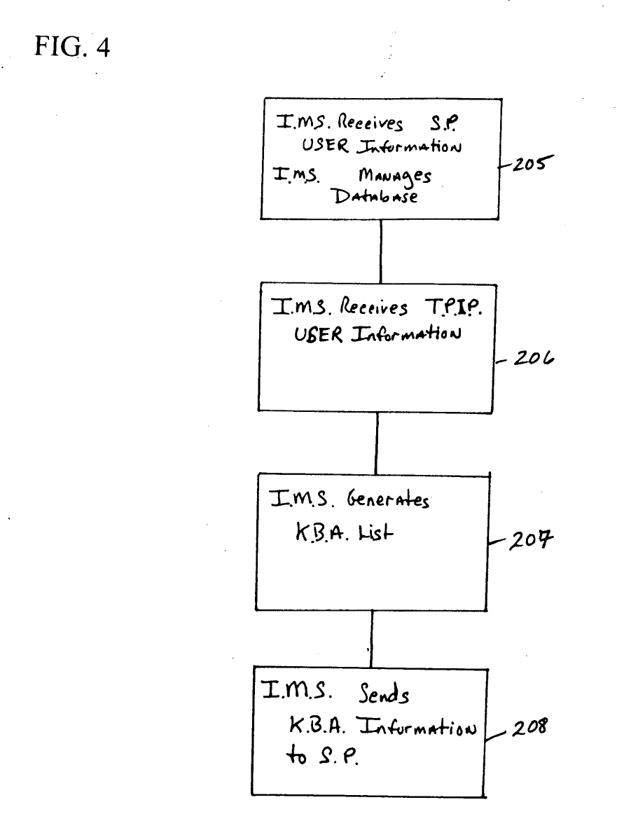

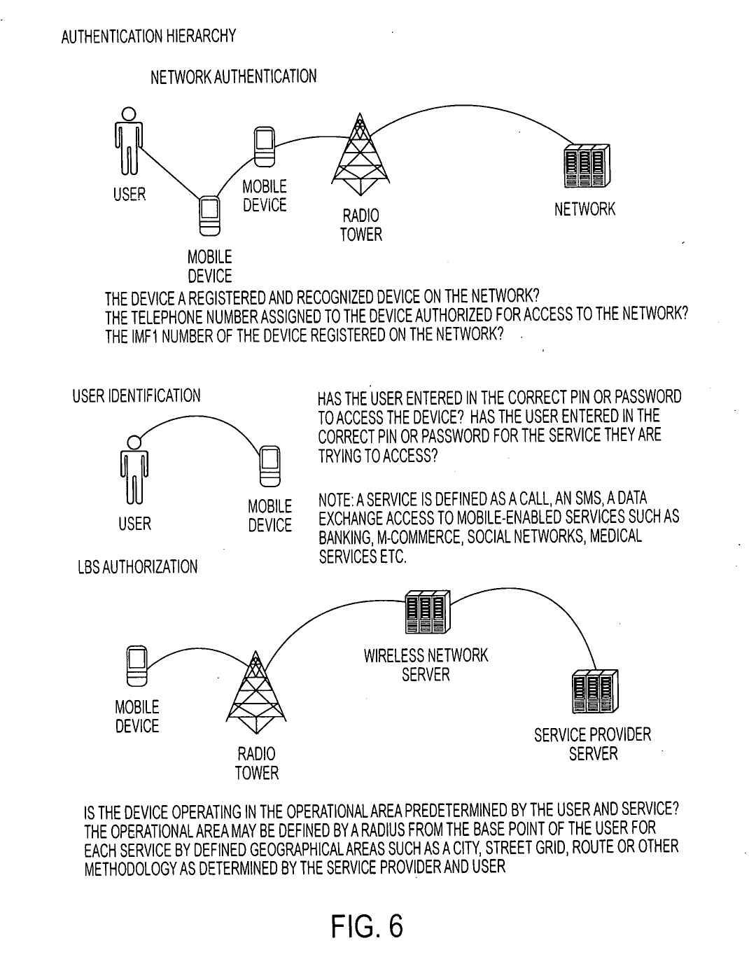

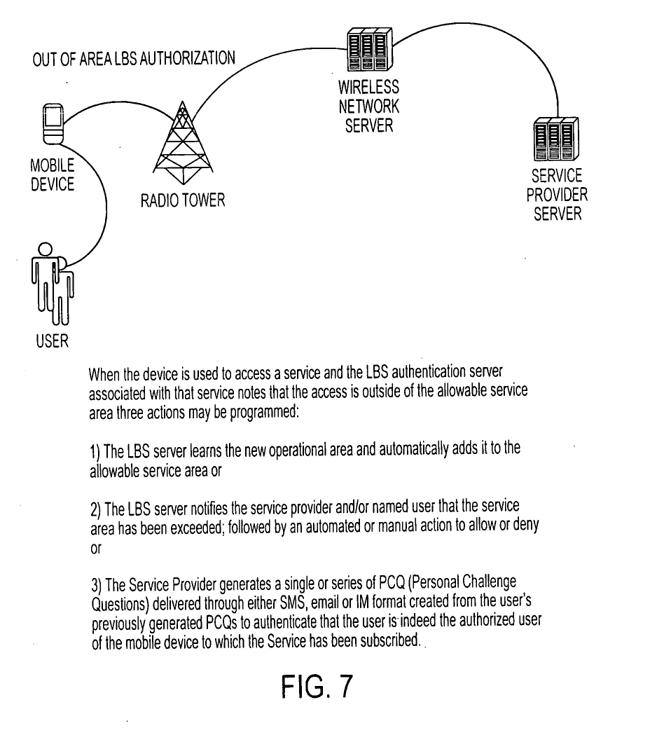

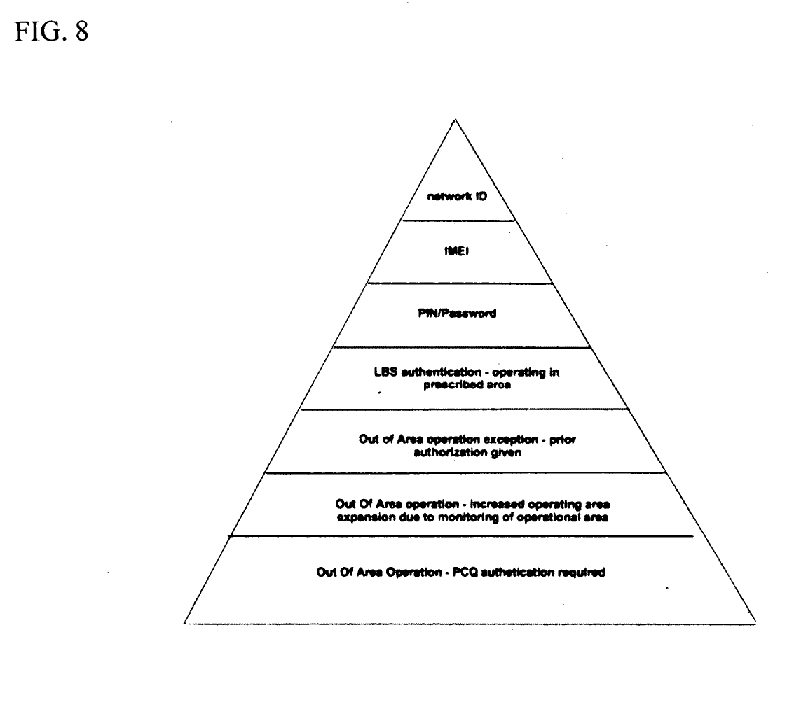

As shown in FIG. 4, the information management system can send 208 one or more KBA questions to the service provider system, such as when a user requests a service and a process of validation calls for use of KBA's by the service provider. The service provider system 120 can provide one or more KBA questions to a user or a user device 110 for an individual to answer. An individual can view the KBA questions on a user device 110 and, by using the device, provide a response which can be compared by the system to a stored answer to a KBA question. Alternatively, or in addition, the user device 110 can provide KBA answers corresponding to KBA questions, which answers may be previously stored in the device. The user and/or user device can provide the response(s) to the service provider 120 and the responses can be used by the system to determine whether or not the user's response to the KBA question presented matches a stored answer associated with the KBA question.

In an alternative embodiment of a system according to the invention, the individual's response and/or responses and can be sent to the information management system 130, and can be used by the IMS 130 to determine whether the individual's responses match associated KBA answers.

In an alternative embodiment the user's response(s) can be forwarded to a TPIP for comparison. Embodiments of the invention include systems where processes for comparison of KBAs and associated answers are provided by a provisioning module at the service provider 120 and/or the information management system 130. In a further embodiment, the information management system does not compare answers against questions, and passes the questions from a credit reporting agency or TPIP to the user, forwards the user's response to the credit reporting agency or TPIP, and receives a validation response from the credit reporting agency or TPIP identifying whether the user's response is correct, or substantially correct to provide a positive validation response. If the individual's answer matches each corresponding KBA answer, the individual's identity is authenticated for purposes of the system and the service provider (or information management system through the service provider) can provide an acknowledgement of positive validation or authentication to the individual. Preferably, an exact match is required each time.

Preferably, the system does not provide access to any user information by means of a password, but instead can require a user to answer a series of personal challenge questions, such as at least 3 PCQs, before access to a service is provided. At time of service subscription, the system can present the user with the opportunity to choose at least 5 PCQs and answers, which PCQs the system can present to the user later to answer when a user desires to access the service and their profile.

In an alternative embodiment of a system according to the invention, the information management system and/or service provider can present 208 one KBA question at a time and then compare 210 the individual's submitted answer to a corresponding KBA answer prior to presenting the next KBA question.

If an individual's answer fails to match an associated KBA answer, the information management system and/or service provider can respond with a negative validation or authentication status to the individual and/or service provider. The service provided can then decide how to act upon the information that the authentication by the user failed. In addition, or in the alternative, other responses to failure to correctly answer a KBA can be provided, including limiting the number of further attempts provided to the user to answer additional KBA questions, locking the user account, auditing the user account, and providing exponentially increasing delays before presenting additional KBA questions. A user can be given a limited number of times to respond to a question, and a time can be provided, which can increase or decrease with each subsequent KBA question. For example, for responses to KBA's or PCQ's the information management system can provide a time limit, such as 45 seconds, for a user to submit a response.

After an individual's identity has been positively authenticated 202, the system provides a process for binding 203 a user's mobile communication device with the user's account. The service provider can prompt the individual or user device to nominate 211 one or more mobile devices to be associated with the individuals' authenticated identity. In the alternative, the service provider can prompt the individual or user device to nominate one or more mobile devices to be associated with one or more services offered by the service provider.

The service provider can also prompt the individual or user device to provide profile information 203 associated with the nominated service. Profile information can include information used to facilitate the authentication of the individual's identity and to provide information to enable the individual to securely access their profile. For example, the service provider may request information to assist later verification of an individual's identity, and/or secure access information, such as a PIN or a password. In addition, or in the alternative, the service provider can request a user to choose one or more personalized challenge questions (PCQs) as part of the registration process 203. The service provider can indicate to the user that the PCQs are intended to be asked whenever the user is required to later validate their identity after initial authentication, such as when users desire to avail themselves of the services of the service provider.

Personalized challenge questions (PCQs) can be provided by the information management system to the service provider as a list of questions. All or a portion of the list of PCQs provided by the information management system the service provider can be presented to a user, such as by sending one or more PCQs to the user device. An individual can choose one or more questions and provide a corresponding PCQ answer as part of the registration process 203. Personalized challenge questions can include one or more knowledge based authentication questions, and can also include other questions drawn from a list of non-personalized PCQs, as well as questions formulated by the user. For example, “what is your favorite color?”, “where do you live?”, “where did you use to live?”, “who was a co-signer on your mortgage?”

PCQs can be chosen from a list of possible questions, which list can include dummy questions. In one embodiment the information management system defines the initial PCQs, and later may allow the user to write their own questions and answers for PCQs. Preferably, the system offers a plurality of PCQs for a user to choose to answer. After the PCQs are chosen by a user and the user has provided its associated answers, the chosen PCQs and associated PCQ answers can be sent 204 to the information management system by the service provider and stored 205 by the IMS.

Preferably, the service provider does not retain the personal challenge questions or their associated answers after the PCQ information is provided to the information management system. The information management system can store 205 the PCQ information, as well as a user's initiation information and the individual's secure information in one or more records associated with user. In one embodiment, the information management system can maintain 205 user records to distinguish information associated with each service and/or service provider.

As shown in FIG. 5, an operational area can be defined during the initial authentication process or added as a feature offered by the service provider after initial authentication for use with a validation process. For example, the operational area can be the area where a user would access the service. In embodiments of the invention, an operational area can be defined by a radius from a base point, which can represent a locus for services to be accessed by the user. In addition, or in the alternative, operational areas or communications providers, sections of a predetermined grid, zip codes, areas codes, geographical and/or political boundaries among other things can be user to establish one or more operational areas. An operational area can be defined by the service provider for a user at service subscription (i.e., inception), and can forward the location information to an LBS module of the information management system.

In one embodiment, the operational area is chosen by the service provider to satisfy the service provider's requirements. For example, a service provider for medical insurance services can define an operating area by zip code, radius from a user's home address, and/or assign certain GPS spots where the mobile device can be used to validate the user for services subscribed to by the user with the service provider, which can included pre-assigned doctors and clinics having associated location information.

When a user desires to access services of the service provider, the user device can send location information to the information management system. The LBS module of a system according to the invention can determine whether the location information of the mobile device forwarded to the information management system matches the location information provided to the IMS by the service provider, and determine when the information does not match. For example, in a second embodiment of the invention adapted for use with providers of medical services, and when the user goes to a doctor or provider not initially subscribed to by the user with the service provider, the information may not match. Thus, the information management system can provide the service provider with a negative LBS authentication response indicating that the device failed to authenticate within the LBS parameters set by the service provider. Accordingly, the service provider can determine what action to take, such as asking the doctor or provider in the above example to further validate the user—either by traditional driver's license or with PCQs the service provider provides to the onsite provider, among other things.

In a further embodiment, the information management system can permit the service provider to add additional notification detail at subscription. For example, the service provider can set parameters on permissible transactions within the services subscribed to by the user, such as a maximum transaction amount, in an embodiment adapted for services including transactions having quantities. In addition, or in the alternative, transaction types can be defined by the service provider at subscription. The service provider sends 203 the parameter limitations to the information management system which can determine whether the parameters have been met each time a user device requests validation for access to a service.

As shown in FIG. 6, a method and system according to the invention can include one or more processes for verifying an individual's identity including use of PCQs and KBAs as described above. Verification is provided after the user's initial authentication and registration with one or more service providers and/or information management systems. For example, embodiment of the invention can include processes wherein at subsequent log-ins to a secure provider's web portal by a user to access services, or when a user is physically present at a service provider's facilities—such as a doctor's office associated with the service provider—the user can be requested by the service provider to verify the user's identity and verification processes can be initiated. In addition, or in the alternative validation processes can be performed via a simple interactive SMS or delivered through the service interface.

In different embodiments, requests for verification can be triggered by a number of conditions, including when a user accesses services of the service provider, and/or when a service provider communicates to an information management system that a service request has been made, and/or when an information management system communicates to the service provider and/or user device that a request for verification be made. For example, as shown in FIG. 7, when a system according to the invention determines that a user device is operating outside its designated area for location based services (LBS) a request for verification can be made. The service provider can allow a user to make changes to a previously defined operational area, which modifications the IMS can receive for later authentication. Accordingly, the service provider provisioning system and/or the information management system can be adapted to trigger a request for verification upon predetermined conditions, which conditions can be set and/or modified according to different factors, for example, the type of service and/or level of security.

An embodiment of the information management system can be further adapted to modify 205 its responses when it receives information from a user device. In one such embodiment, the information management system receives 205 service provider information, including parameters established by the service provider, for the IMS to determine whether information received from the user device meets the parameters of the service provider. The IMS can include a module for tracking conditions and behavior patterns of a user which can be governed by a database associated with the information management system and which records a user's compliance with the parameters established by the service provider. For example, a system according to the invention adapted for theft prevention of an automobile, a service provider can key in a mobile device or devices authorized to operate the vehicle. A parameter can be provider to determine whether or not the user of the vehicle is an authorized user, such as by determining whether or not the operator is in the automobile, as well as combining geographical parameters for authorized area of use.

Verification processes can include either the service provider or information management system to requesting a user and/or user device to answer one or more PCQs associated with the user and/or user device and presenting one or more PCQs. The verification process can include receiving a response from a user or user device and comparing one or more responses to a stored PCQ answer associated with the presented PCQ. As another example, when a user exceeds the operating parameters (this can be geographical, dollar amount of a purchase, etc.) set by the service provider, an additional layer of validation can be initiated whereby the service provider sends an SMS to the user's mobile device that asks one or more PCQs to be answered by the user to validate it is them. An alternate delivery method in the case where the mobile device is not present at all is to have a set of PCQs sent to the service provider via computer interface, telephone or alternate method that the service provider would ask to the user and then reply on behalf of the user.

As shown in FIG. 8, one or more additional layers of verification can be provided for additional protection. For example, location based services (“LBS”) validation can be used as part of the validation system and processes. LBS can be used as an integral part of any service provider's authentication protocol since it can be customized to each individual service. In some instances if one or more of the operational parameters set by the service provider has been violated, the system can initiate a PCQ process to confirm if the user is the authorized user. Embodiments of a system according to the invention can be provided with an increasing hierarchy of authentication protocols with each additional layer being more intrusive.

If the device is within the operational area, the LBS verification process can return an affirmative response, and if the device is not determined to be within the operational area, the LBS verification process can return a negative response. When an affirmative response is received, the service provider can be notified by the IMS that the verification has passed, such as by an API that the information management service to service provider's system. When an affirmative response is received, the service provider can be notified that the verification has not passed, and the user and/or user device can be notified.

In embodiments, a service provider may permit users to exceed their assigned operational areas. The service provider can provide an option to temporarily modify operational areas to include other geographical areas. The service provider can modify the operational area and ability to exceed it either at time of subscription as well as during use of the service. In some cases the service provider may want to be notified if the service area or parameter has been violated but not to do more than log the violation

A user or user device which fails to satisfy the LBS test may be presented by the service provider with one or more additional verification processes to permit the user to satisfy a service provider's verification requirements. For example, the service provider may deem the LBS test satisfied if the user or user device is able to satisfy a PCQ test. Upon satisfaction of the PCQ test or other verification process requested by the service provider, the service provider may provide user and/or user device the option to add to modify the user's operational area, such as by increasing the radius of a defined point, adding a new defined point and new radius, among other things. For example, in embodiments, a user can be permitted to change service provider parameters established at subscription, such as providing additional locations for use of the subscriber's service. In an alternative embodiment, the user device can send a query to a service provider to add a new location.

In an alternative embodiment, the LBS can be used as a tracking module in which the mobile device provides LBS position information to the IMS to log location, and thereby can identify the locations where a service is being accessed and/or can modify the operational area of the user to accommodate the change in operational areas. As an example, a user can send information to add a new location, which can be especially useful for embodiments adapted for courier related services.

As shown in FIG. 8, embodiments of a system according to the invention include validating processes which are performed in a hierarchal sequence. A hierarchal process can be provided to the service provider and/or information management system that will establish a relative priority to each separate validation process used by the embodiment of the system. In one embodiment, an order of priority includes, determining whether the mobile device is registered for the specific service detected; determining whether PIN/Password is accepted; determining whether a user's response to a SMS challenge is correct; determining whether an LBS operating area is within predetermined parameters; determining whether user responses to PCQs are correct if LBS is returns an out of area response.

In addition, separate validation processes can include matching the user identity with the user identification associated with the mobile telephone number of the mobile device. In an embodiment of the invention, a service provider can provide one or more parameters to instruct the IMS to validate the user merely if the mobile device is present so when a user is at the point of service the service provider would be provided with access to the requested services. For example, the service provider can communicate with the IMS via an API provided by the IMS and request that the IMS confirm if the mobile device is present at a specific location. In such an embodiment, the IMS can ping the mobile device and provide the LBS location after which the service provider compares that against their list of locations to determine if the mobile device is where the yet-to-be validated user is located. In addition, or in the alternative, the service provider can provide all the LBS/GPS locations for each user profile to the IMS and the IMS check the LBS of the user device upon a request to see if the user location according to the mobile device is where the user is requesting services of the service provider.

In addition, or in the alternative, a validation process can include determining whether the IMEI of the user device present at the request for services matches a corresponding IMEI record of the user device bound to the user. The IMEI and telephone number validation can be performed by the IMS or the operator system of the mobile user communications device. It can be appreciated that certain information concerning a user device may be available from a communications service, such as when the user device is a mobile phone.

In addition, or in the alternative, a validation process can include requesting a user's PIN or password, and determining whether the PIN or password matches a corresponding PIN or password associated with the user. For example, a service provider may provide parameters to the IMS to either ping the user with an SMS challenge for PIN or Password, or the service provider may provide that challenge request to the user such as at the point of service.

Another validation test can employ a LBS verification process to match the prescribed operational area, as described above. In addition, or in the alternative, a further validation process can include PCQ validation processes wherein the user can be prompted to answer one or more PCQs. For example, if the IMS determines from the LBS that the user device is outside an operational area parameter provided by the service provider to the IMS, or if a particular transaction is of a type that violates other service provider preset conditions (for example, then the IMS can perform a PCQ validation process.

Accordingly, an embodiment including validation processes performed in a hierarchal order can include performing a selection of tests, i.e., validation processes, wherein failure of a user or user device to validate an identity by one of the tests, can prompt an additional test to be performed. Preferably, the hierarchy provided in an embodiment provides an increasing amount of intrusion or interaction by the user for each layer of authentication.

In embodiments of the invention including a hierarchal validation process involving more than one validation test, the validation process can include a return to the initial authentication process for validation if all validation tests in the hierarchy have failed. In such embodiments, preferably the initial authentication process is more robust and secure than the other validation processes employed.

### CONCLUSION

The invention has been described in connection with certain preferred embodiments. It will be appreciated that those skilled in the art can modify such embodiments without departing from the scope and spirit of the invention that is set forth in the appended claims. Accordingly, these descriptions are to be construed as illustrative only and are for the purpose of enabling those skilled in the art with the knowledge needed for carrying out the best mode of the invention. The exclusive use of all modifications and equivalents are reserved as covered by the present description and are felt to be within the scope of the appended claims.

1. A method for mobile identity verification and security, comprising
initializing a user profile, wherein said initializing step includes
receiving initial user identification information,
authenticating a user identity based on said initial user identification information,
binding a mobile user communications device with the user profile and obtaining a mobile user communications device identification information,
receiving service provider parameters from a service provider, said service provider parameters including location based services parameters,
and receiving service provider information;
receiving a request for user access to services of a service provider, and
validating said request for access,
wherein said validating step includes at least one validation process selected from the group of validation processes comprising
validating a user identity with a personalized challenge question,
validating a user identity with a knowledge-based authentication question,
validating a user identity with device identification information, and
validating the request for user access to services of a service provider with at least one of said service provider parameters, and
wherein said at least one validation process is presented in a hierarchal order.
